(19) United States
(12) Patent Application Publication
(10) Pub. No.: US 2011/0290628 A1
(43) Pub. Date: Dec. 1, 2011

(54) MEMBRANE KEYBOARD WITH PARTS BEING FIXEDLY SECURED TOGETHER

(75) Inventor: HUO-LU TSAI, Taichung Hsien (TW)

(73) Assignee: Sunrex Technology Corp, Taichung Hsien (TW)

(21) Appl. No.: 12/790,930

(22) Filed: May 31, 2010

(51) Int. Cl. H01H 13/76

(52) U.S. Cl. 200/5 A

(57) ABSTRACT

A membrane keyboard includes transparent keys, bridge structures each with the key mounted thereon, a plastic board, a frame board, a film circuit board, an insulative board, a light guide film plate, a base board, and fasteners for fastening the plastic board, the frame board, the film circuit board, the insulative board, and the light guide film plate on the base board. The plastic board, the frame board, the film circuit board, the insulative board, the light guide film plate, the base board, and the fasteners are secured together by subjecting to ultrasonic welding.

### BACKGROUND OF THE INVENTION

1. Field of Invention

The invention relates to membrane keyboard and more particularly to a membrane keyboard with its thermoplastic parts being secured together by subjecting to ultrasonic welding.

2. Description of Related Art

Laptops are widely used by people throughout the world due to their portability, Internet access capability, office applications, and other features. Typically, membrane keyboards are employed by laptops. For a membrane keyboard, bridge structures are provided between surface keys and a base board. The membrane keyboards are advantageous for being thin, lightweight, and compact. However, most types of laptops are only suitable to operate in a bright environment since there is no backlight device provided. For overcoming above drawback, many prior keyboard patents with backlight arrangement are disclosed. For example, Taiwanese Utility Model Patent No. M306,689 discloses a keyboard with backlight arrangement. However, in practice it is found that keys distal the LED (light-emitting diode) based backlight arrangement are not sufficiently illuminated. That is, keys are not illuminated uniformly.

The invention described later is an outgrowth of earlier work by the inventor hereof, described in U.S. Pat. No. 7,608,792. The patent, entitled “Membrane keyboard/keypad with arrangement for uniformly lighting keys from background”. The teachings of the patent are incorporated herein by reference. The patent has been successfully used in a commercial application. However, in practice it is found that light emitted from the electrically powered luminescence board passing the light permeable frame board and the keys are not sufficiently lit to uniformly illuminate characters, symbols or patterns on the keys. Moreover, the film circuit board, the light guide film plates, and the insulative board are adhesively secured together to form a stack. However, such fastening is not reliable, components positioning is not precise, and quality is poor. Thus, the need for improvement still exists.

### SUMMARY OF THE INVENTION

It is therefore one object of the invention to provide a membrane keyboard comprising a plurality of transparent keys, a plurality of bridge structures of X cross-section each with the key mounted thereon, a plastic board, a frame board, a film circuit board, an insulative board, a light guide film plate, a base board, and a plurality of fasteners for fastening the plastic board, the frame board, the film circuit board, the insulative board, and the light guide film plate on the base board, wherein the plastic board is rectangular and comprises a plurality of apertures; each fastener is formed of plastic and has an enlarged head and a stem extending downward; the frame board is disposed under the plastic board and comprises a plurality of through holes each aligned with the fastener; the film circuit board is transparent and comprises a plurality of LEDs electrically connected thereto, and a plurality of through holes each aligned with the fastener; the insulative board is optically transmissive, formed of elastomeric, and is disposed under the film circuit board, the insulative board comprises a plurality of through holes each aligned with the fastener; the light guide film plate is disposed between the insulative board and the base board, and comprises a plurality of joining members each aligned with the fastener; the stem of each fastener is driven through the aperture and the through holes to contact the joining member; and the plastic board, the frame board, the film circuit board, the insulative board, the light guide film plate, the base board, and the fasteners are subject to ultrasonic welding to secure them together.

The above and other objects, features and advantages of the invention will become apparent from the following detailed description taken with the accompanying drawings.

### BRIEF DESCRIPTION OF THE DRAWINGS

FIG. 1 is an exploded view of a membrane keyboard according to the invention;

FIG. 2 is a fragmentary, exploded view of FIG. 1 with a single key assembly being illustrated;

FIG. 3 is a perspective view of some components of FIG. 2 being assembled together;

FIG. 4 is a longitudinal sectional view of the components of FIG. 2 being assembled;

FIG. 4A is a detailed view of the area in circle A of FIG. 4; and

FIG. 5 is a view similar to FIG. 4 showing elastic deformations of underlying components after pressing the key thereon.

### DETAILED DESCRIPTION OF THE INVENTION

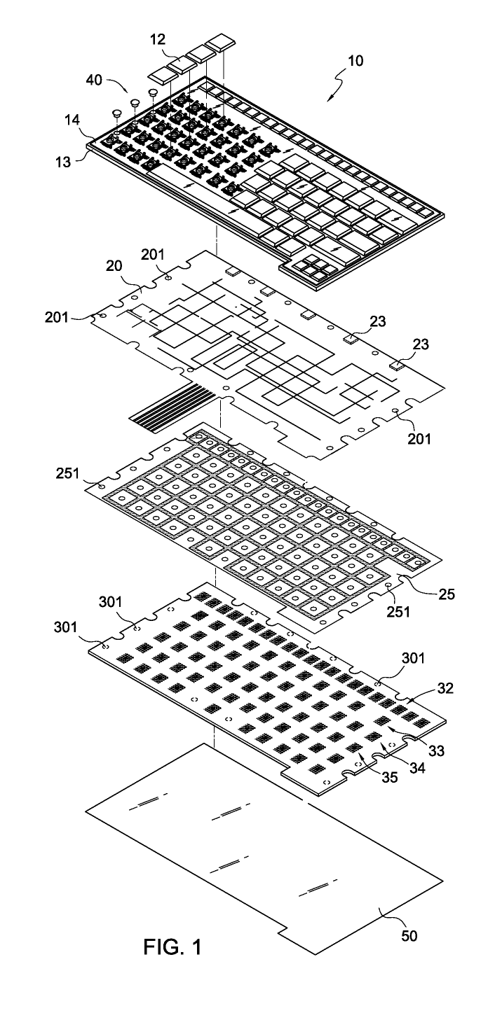

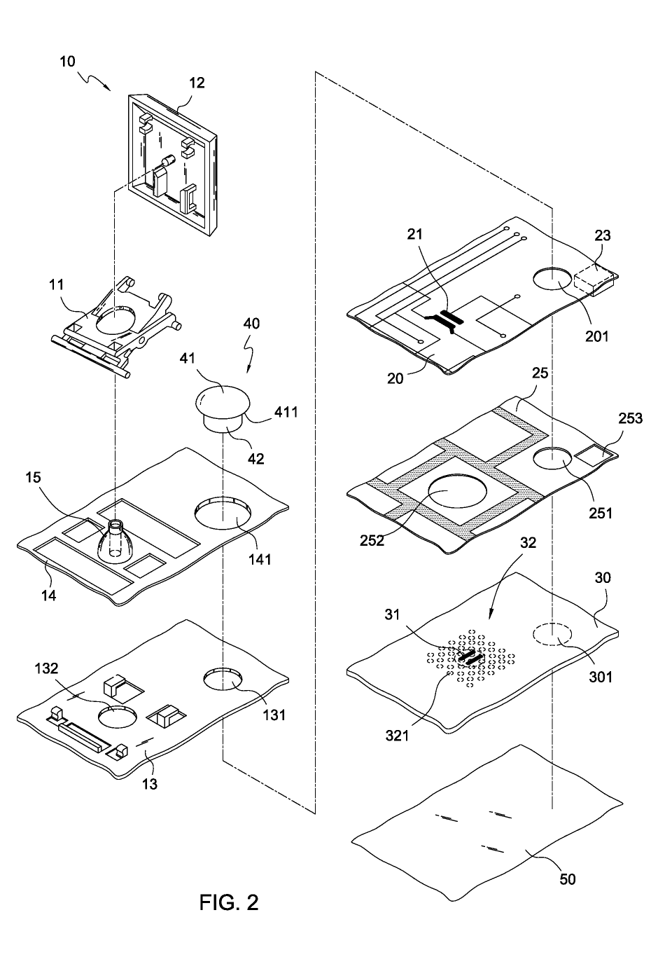

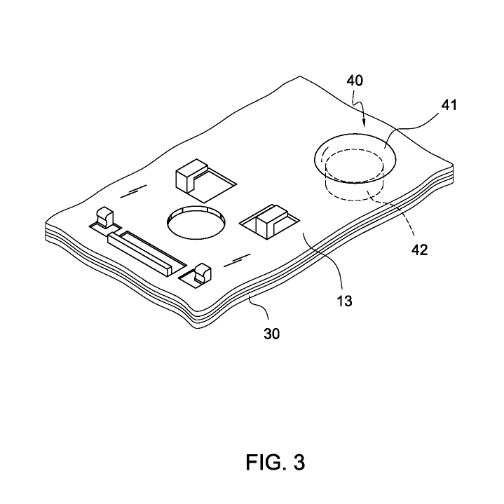

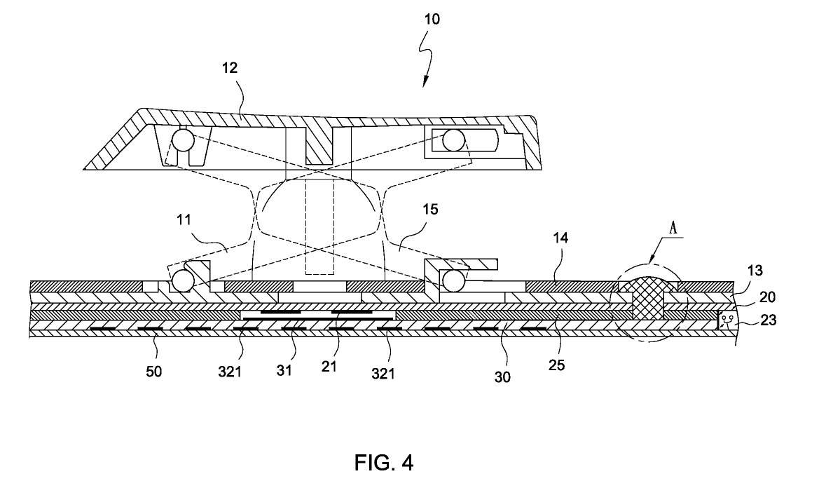

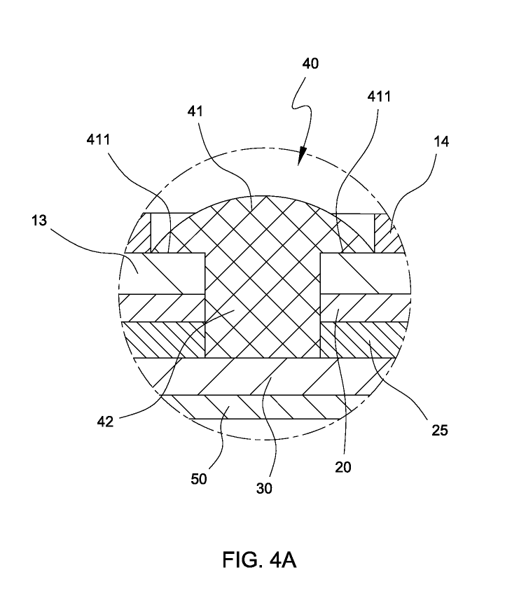

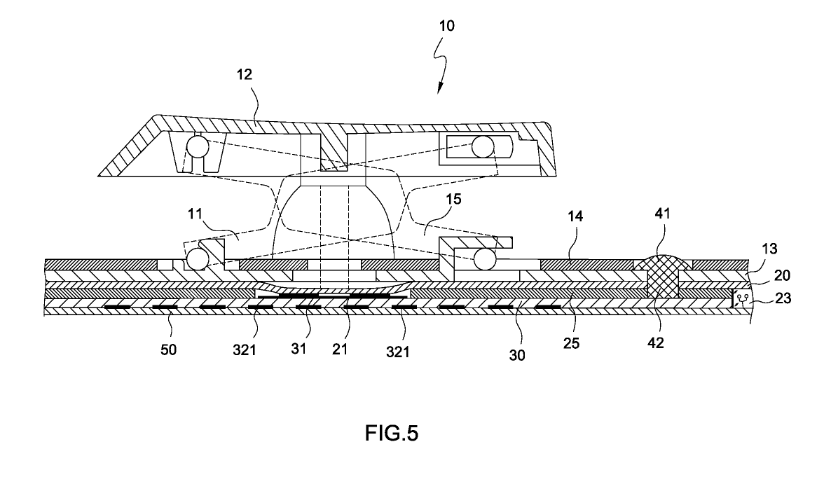

Referring to FIGS. 1 to 5, a membrane keyboard 10 in accordance with the invention comprises the following components as discussed in detail below.

A plurality of rectangular bridge structures 11 each is mounted with a transparent square key 12 thereon. The bridge structures 11 of X cross-section are supported by a substantially rectangular plastic board 14 thereunder. The plastic board 14 comprises a plurality of hollow, dome-shaped elastic members 15 each with a central hole of the key 12 put thereon, and a plurality of circular through holes 141. A substantially rectangular frame board 13 is disposed below the plastic board 14 comprises a plurality of through holes 132 each aligned with the elastic member 15, and a plurality of first through holes 131 each aligned with the through hole 141. A central stem extending downward from a bottom of the key 12 is inserted into the elastic member 15 for anchoring and bottom axles of the bridge structure 11 are rotatably fastened on the frame board 13 so that the key 12 can be depressed as known in the art.

A transparent film circuit board 20 is provided under the frame board 13 and comprises a plurality of second through holes 201 each aligned with the first through hole 131, a plurality of contacts 21 each with the elastic member 15 disposed thereabove, and a plurality of LEDs (light-emitting diodes) 23 each adjacent to the first through hole 131. An optically transmissive insulative board 25 is formed of elastomeric and is disposed under the film circuit board 20. The insulative board 25 comprises a plurality of fourth through holes 252 each aligned with the contact 21, a plurality of third through holes 251 each aligned with the first through hole 131, and a plurality of rectangular holes 253 each besides the third through hole 251 with the LED 23 fitted thereinto.

A light guide film plate 30 is formed of transparent silicone rubber and is provided under the insulative board 25. The light guide film plate 30 comprises a plurality of circular joining members 301 and a plurality of light diffusing areas 32. Each light diffusing area 32 is disposed a predetermined short distance right below a corresponding one of the keys 12. Further, each of the light diffusing areas 32 and its corresponding key 12 substantially have the same area. Each light diffusing area 32 comprises a top contact 31 disposed under the contact 21 by a predetermined short distance, and a plurality of light diffusing members 321 on bottom formed by printing. A substantially rectangular base board 50 is provided with both the light guide film plate 30 and the LEDs 23 and rested thereon.

A plurality of plastic fasteners 40 each has an enlarged head 41 and a stem 42 extending downward. An annular shoulder 411 is formed between the head 41 and the stem 42.

An assembly of the invention will be described in detail below. The light guide film plate 30 is placed on the base board 50. The insulative board 25 is placed on the light guide film plate 30 with the third through holes 251 aligned with the joining members 301 and the fourth through holes 252 aligned with the light diffusing areas 32. The film circuit board 20 is placed on the insulative board 25 with the contacts 21 aligned with the fourth through holes 252, the second through holes 201 aligned with the third through holes 251, and the LEDs 23 rested upon the light guide film plate 30. The frame board 13 is placed on the film circuit board 20 with the through holes 141 aligned with the second through holes 201. The plastic board 14 is placed on the frame board 13 with the through holes 141 aligned with the first through holes 131 and the elastic members 15 aligned with the contacts 21. The bridge structures 11 are mounted on the elastic members 15. The keys 12 are mounted on both the bridge structures 11 and the elastic members 15. Diameters of the stem 42 and the through holes 131, 201, and 251 are the same. Diameters of the through holes 131, 201, and 251 are less than that of the through hole 141. Hence, each stem 42 can pass through the through holes 141, 131, 201, and 251 until being stopped by the joining member 301 with the shoulder 411 urging against the mouth of the through hole 131 on the frame board 13 and the head 41 slightly projecting out of the through hole 141. The above precisely stacked components are subject to ultrasonic welding to secure these thermoplastic components together. For example, the stems 42 are secured to the joining members 301, the insulative board 25, the film circuit board 20, and the frame board 13. The plastic board 14 is fastened by the fasteners 40. As a result, a quality membrane keyboard is manufactured.

It is noted that the light diffusing members 321 are different in terms of depth, size, and density corresponding to different distances from the LEDs 23. This can ensure that light emitted by the LEDs 23 is substantially uniformly directed upward toward the keys 12 through the light diffusing areas 32. Hence, the keys 12 are lit uniformly when the laptop is turned on.

It is further noted that a pressing of the key 12 may lower its stem to depress the bridge structure 11, elastically deform the elastic member 15, and cause the contact 21 to electrically connect to the contact 31. As a result, a switch is “closed” and the depressed key 12 is activated. It is understood that a release of the key 12 will elastically return the key 12 to its rest position.

While the invention herein disclosed has been described by means of specific embodiments, numerous modifications and variations could be made thereto by those skilled in the art without departing from the scope and spirit of the invention set forth in the claims.

What is claimed is:

1. A membrane keyboard comprising a plurality of transparent keys, a plurality of bridge structures of X cross-section each with the key mounted thereon, a plastic board, a frame board, a film circuit board, an insulative board, a light guide film plate, a base board, and a plurality of fasteners for fastening the plastic board, the frame board, the film circuit board, the insulative board, and the light guide film plate on the base board, wherein:
the plastic board is rectangular and comprises a plurality of apertures;
each fastener is formed of plastic and has an enlarged head and a stem extending downward;
the frame board is disposed under the plastic board and comprises a plurality of through holes each aligned with the fastener;
the film circuit board is transparent and comprises a plurality of LEDs electrically connected thereto, and a plurality of through holes each aligned with the fastener;
the insulative board is optically transmissive, formed of elastomeric, and is disposed under the film circuit board, the insulative board comprises a plurality of through holes each aligned with the fastener;
the light guide film plate is disposed between the insulative board and the base board, and comprises a plurality of joining members each aligned with the fastener;
the stem of each fastener is driven through the aperture and the through holes to contact the joining member; and
the plastic board, the frame board, the film circuit board, the insulative board, the light guide film plate, the base board, and the fasteners are secured together by subjecting to ultrasonic welding.

2. The membrane keyboard of claim 1, wherein the keys are square, each key has a downward stem fastened in the bridge structure, and bottom axles of the bridge structure are rotatably fastened on the frame board so that the key is adapted to press to compress the bridge structure.

3. The membrane keyboard of claim 1, wherein the plastic board further comprises a plurality of elastic members each with the key disposed thereon so that a pressing of the key will depress the elastic member to electrically conduct the film circuit board.

4. The membrane keyboard of claim 1, wherein diameters of the stem of the fastener and the through holes are equal, and the diameters of the through holes are less than that of the aperture.

5. The membrane keyboard of claim 1, wherein an annular shoulder is formed between the head of each fastener and the stem thereof, the shoulder being urged against the mouth of the through hole of the frame board.

6. The membrane keyboard of claim 1, wherein the light guide film plate further comprises a plurality of light diffusing areas each disposed a predetermined distance below a corresponding one of the keys, each of the light diffusing areas comprising a top contact and a plurality of bottom light diffusing members, and the light diffusing members are different in terms of depth, size, and density corresponding to different distances from the LEDs so that light emitted by the LEDs is substantially uniformly directed upward toward the keys through the light diffusing areas to uniformly light the keys.

7. The membrane keyboard of claim 6, wherein the film circuit board further comprises a contact, disposed above the contact of the light guide film plate so that a depressing of the key causes the contact of the film circuit board to electrically connect to the contact of the light guide film plate.

8. The membrane keyboard of claim 1, wherein the plastic board, the frame board, the film circuit board, the insulative board, and the light guide film plate are supported on the base board.
